(19) United States
(12) Patent Application Publication
(10) Pub. No.: US 2006/0067076 A1
(43) Pub. Date: Mar. 30, 2006

(54) Combination lamp holder

(76) Inventors: William W. Shiang, St. Louis, MO (US); Richard W. Ursch, Fenton, MO (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/953,963

(22) Filed: Sep. 29, 2004

(51) Int. Cl. F21V 19/00

(52) U.S. Cl. 362/288; 362/650

(57) ABSTRACT

The present invention relates to a lamp holder that can align a lamp with respect to a lamp holder and further secures the lamp against loosening caused by environmental vibrations (i.e., vibrations that are germane or inherent to the specific lighting application in which the lamp holder is installed). In one embodiment, a conductive sleeve is provided that includes a threaded portion for receiving an associated lamp; a positioning element located near the top portion of the conductive sleeve for engaging an alignment prong (or projection) of the associated lamp; and at least one vibration dampener formed in a portion of the conductive sleeve, wherein the vibration dampener and the positioning element ensure that the lamp will not vibrate excessively and/or become misaligned with respect to the holder.

### BACKGROUND OF THE INVENTION

1. Technical Field

The present invention relates to lamp holders for receiving lamps and more particularly to lamp holders for use in a wide range of environments where a relatively high degree of alignment with respect to other components of the light fixture (such as for aiming or focusing) may be desired and/or where resistance to environmental factors, such as vibration, may be desired.

2. Description of the Related Art

Lamp holders (or lamp sockets) are generally designed to hold a light bulb (or lamp) in a light fixture so as to distribute various levels of light over a specific location. Orientation of the lamp within the lamp holder may affect light distribution. For a variety of lighting applications, such as athletic fields, gymnasiums, roadways, factories, warehouses, etc, proper orientation of the lamp within a lamp holder is desired to ensure proper light distribution. If light is not properly distributed, it is possible to have a variety of undesirable results, such as non-uniform light distribution, dark spots or unwanted glare in critical high traffic areas (e.g., on floors and roadways), etc. In order to alleviate or overcome some of these undesirable results, current applications may include more light sources than necessary. A drawback with increasing the number of light sources is the additional costs associated with the acquisition of the light source, installation costs, operational costs and maintenance costs.

In many applications, there may be certain physical effects that affect the orientation of the lamp (or bulb). Many of the physical effects are directly related to the environment in which the lamp holder is placed (e.g., spectators stomping on bleachers, traffic or construction work on roadways, vibrations caused by heavy machinery in factory and warehouse applications, etc.). These physical effects may transmit undesirable vibrations to the light fixture that may result in a change in lamp (or bulb) orientation, which adversely may affect light distribution from the fixture.

Lighting applications that entail precise alignment (or focusing) of lamps in such environments generally call for significant maintenance to ensure proper lamp (or bulb) alignment. Since such maintenance is typically performed by individuals with the aid of expensive lifting equipment (e.g., cranes, transports, etc.), the cost of maintenance associated with ensuring proper orientation and alignment of lamps (or bulbs) is significant.

Thus, there is a strong need for a lamp holder (or lamp socket) that combines the ability to precisely align (such as for proper focusing and/or aiming) a lamp and is also resistant to vibrations caused by the particular environment in which the lamp holder (or lamp socket) is installed.

### SUMMARY OF THE INVENTION

The present invention is directed to a lamp holder that includes: a positioning element and at least one vibration dampener for engaging an associated lamp, which ensures that the associated lamp will not vibrate excessively and become misaligned.

One aspect of the present invention relates to an apparatus including a conductive sleeve including a top portion, a central portion and a bottom portion, wherein at least one portion of the conductive sleeve is at least partially threaded for receiving an associated lamp; a positioning element located near the top portion of the conductive sleeve; and at least one vibration dampener secured to a portion of the conductive sleeve.

Another aspect of the present invention relates to a lamp holder that includes: a body made of an insulating material that forms a socket; a conductive sleeve secured to the body, the conductive sleeve having a top portion, a central portion and a bottom portion, wherein at least one portion of the conductive sleeve is at least partially threaded; a positioning element located near the top portion of the conductive sleeve; and at least one vibration dampener formed in a portion of the conductive sleeve.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a perspective view of a lamp holder in accordance with one aspect of the invention and an associated lamp;

FIG. 2 is a cross-sectional view of a lamp holder in accordance with one aspect of the invention;

FIG. 3 is a cross-sectional view of a lamp holder in accordance with one aspect of the invention;

FIG. 4 is a cross-sectional view of a lamp holder in accordance with one aspect of the invention;

FIGS. 5A-5D are cross-sectional views of a lamp holder in accordance with one aspect of the invention;

FIG. 6 is a schematic view of a fixture having a lamp holder in accordance with the present invention.

### DETAILED DESCRIPTION OF THE INVENTION

The present invention relates to lamp holder (or lamp socket) that is capable of precisely aligning a lamp within the lamp holder and further secures the lamp against loosening caused by environmental vibrations (e.g., vibrations that are germane or inherent to the specific lighting application in which the lamp holder is installed). The lamp holder in accordance with one aspect of the invention is arranged to minimize or completely eliminate an associated lamp from vibrating relative to the lamp holder or becoming misaligned relative to the lamp holder in lighting applications where positioning of the lamp is important. Such applications include, for example: lighting in warehouses and plants where vibrations from equipment can cause a lamp to dislodge (or loosen) from the lamp holder and become aimed incorrectly, lighting along highways or busy streets where vibrations from passing traffic can cause the lamp to dislodge (or loosen) and thus be aimed improperly, lighting in stadiums or gymnasiums where vibrations caused by spectators can cause the lamp to dislodge (or loosen) and be aimed improperly, etc.

The lamp holder in accordance with one aspect of the invention may lessen labor costs required to re-position or replace lamps that are dislodged, since the lamp is much less likely to become loose or improperly aimed with the lamp holder disclosed herein, as compared to conventional lamp holders.

Likewise, the lamp holder in accordance with one aspect of the invention may be used with a broader range of lamps than conventional lamp holders. Using conventional lamp holders, lamps that have an alignment prong to fix the location or aim of the lamp generally cannot be used in a lamp holder that has vibration dampeners or grips (an anti-vibration feature). Additionally, lamps that have that do not have an alignment prong are not capable of being used with lamp holders that have an alignment feature.

The lamp holder in accordance with one aspect of the invention allows the same lamps to be used in a wider variety of applications than conventional lamp holders. Thus, distributors and end users are able to keep less inventory items of both lamps and lamp holders on hand.

Likewise, the lamp holder in accordance with one aspect of the present invention provides the opportunity to use different lamps in applications versus what has been traditionally been available. For instance, the lamp holder has a lower profile (a narrower screw shell) than conventional lamp holders (or sockets), which allows bulbs with a smaller profiles to be used. Furthermore, in many instances, the lamp holder in accordance with one aspect of the present invention may reduce the number of lamps and lamp holders for a particular lighting application than would conventionally be used.

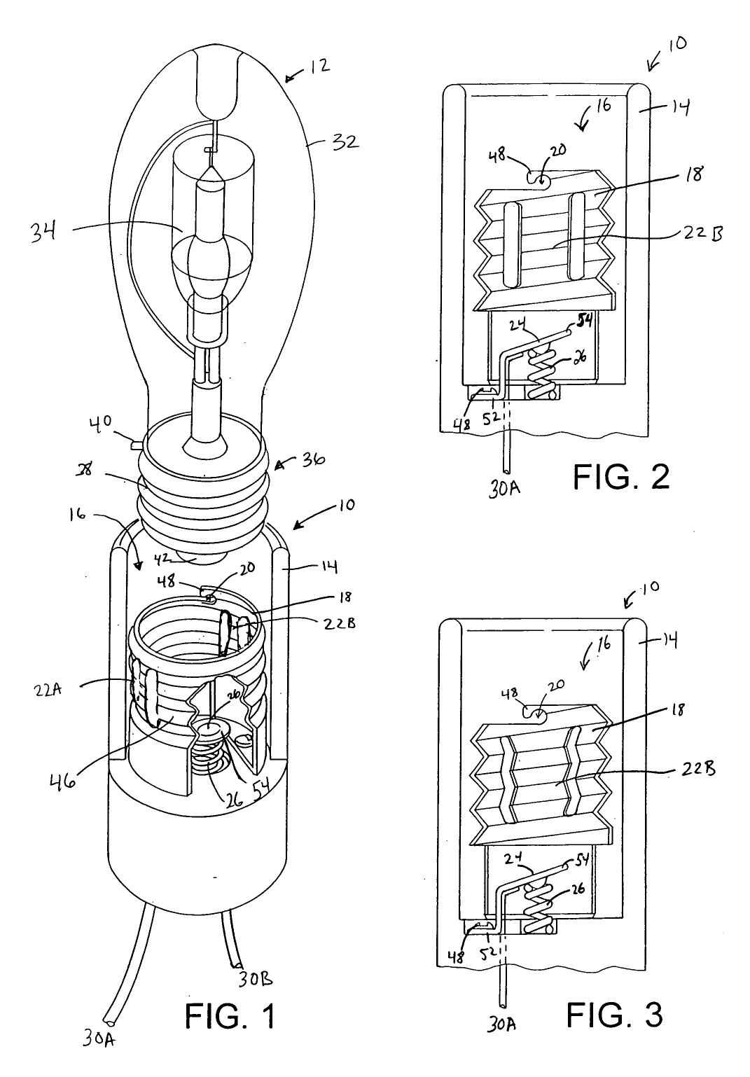

Referring to FIG. 1, a lamp holder (or lamp socket) 10 in accordance with one aspect of the invention is illustrated along with an exemplary lamp 12. FIG. 1 illustrates the lamp 12 exploded from the lamp holder 10, which is shown partially cutaway. With additional reference to FIG. 2, the lamp holder 10 includes a body 14, a socket 16, a conductive sleeve (e.g., metal) 18, a positioning element 20, vibration dampener(s) 22A-22B, a conductive contact arm 24, a coil spring 26, conductor 28, and lead wires 30A and 30B.

The lamp holder 10 accepts and provides full electrical connection with the lamp 12. The lamp 12 may be any type of lamp (e.g., halogen, incandescent, etc.). The lamp 12 generally has a glass bulb 32 that generally covers a filament or arc tube 34 (e.g., a quartz arc tube). Lamp 12 typically has a conductive screw base 36 with the lower portion containing conductive base threads 38. Although lamp 12 is shown with American Standard mogul threads, the lamp 12 may include any screw thread pattern.

The base threads 38 are generally fabricated from a conductive material (e.g. a metal such as copper or a copper alloy). A prong 40 that extends radially outward from the lamp 12 can be located at or near the upper portion of the base threads 38. The prong 40 may be used to engage the positioning element 20 of the lamp holder 10 to assist in proper alignment (e.g., aiming and/or focusing) of the lamp 12. Lamp 12 further includes a relatively flat contact 42, often termed a solder or button. The contact 42 is generally made of a conductive metal and is mechanically, but not electrically, joined to the end of base threads 38 by an insulator 44, such as a non-conductive ceramic as is well known in the art. The base threads 38 are generally connected to one side of arc tube 34 and the contact 42 is connected to the other.

Referring back to the lamp holder 10, the body 14 of the lamp holder 10 may be manufactured from any insulating material. Exemplary insulating materials generally include: rubber, plastic, porcelain, ceramics and the like. Body 14 is generally cylindrical and includes a cavity that forms at least a part of the socket 16. The socket 16 generally contains a conductive sleeve 18 that includes formed threads 46. The formed threads 46 are typically complementary to the base threads 38 of the lamp 12.

As shown in FIGS. 1 and 2, a positioning element 20 is located near the top of the conductive sleeve 18. As shown in the figures, positioning element 20 is integral to the conductive sleeve 18. However, one of ordinary skill in art will readily appreciate that positioning element 20 need not be integral to the conductive sleeve 18. For example, the positioning element 20 may include a separate tubular body that secures to the conductive sleeve 18. The positioning element 20 is capable of engaging a prong 40 extending from the lamp 12 in order to provide precise alignment of the lamp 12 in the lamp holder 10. The lamp holder 10 may be used in connection with lamps having such a prong 40 and those lamps that do not have such a prong.

The positioning element 20 may also include a flared notched end 48. The flared end 48 works in conjunction with the conductive contact arm 24 and the coil spring 26 to ensure that prong 40 of the lamp 12 is secured within the notch 20 and makes it more difficult for the lamp 12 to become misaligned. Once a lamp 12 is installed in the lamp holder 10 (e.g., by rotating the threads 38 and the formed threads 46 of the sleeve 18 together until the prong 40 enters under the flared end 48 and adjacent the sleeve 18 (forming the notch 20)), the coil spring 26 exerts an upward force on the lamp 12 that establishes an intimate contact between the prong 40 and the flared notched end 48, such contact preventing or minimizing inadvertent or unwanted movement of the lamp 12 with respect to the lamp holder 10. In order to remove the lamp 12 from the lamp holder 10, a compressive force is applied to the spring 26 via the lamp 12 (e.g., by pushing downward on the lamp 12) in order to affect a clearance between the prong 40 and the positioning element 20. Then, the lamp 12 is rotated in a counter-clockwise direction.

The lamp holder 10 also includes at least one vibration dampener 22. As shown in FIG. 1, the lamp holder 10 includes two vibration dampeners 22A and 22B. The vibration dampeners 22 may be formed by forming slots 50 (shown in FIG. 1 as 50A and 50B) in the conductive sleeve 18. Accordingly, each vibration dampener 22 is a portion of the sleeve 18 that is disposed between a pair of slots 50. The vibration dampener 22 can be bent radially inward relative to the remainder of the sleeve 18. The vibration dampener 50 may also be formed from one vibration dampener 20, which is formed by a single depression that decreases the radius within the sleeve 18.

The length of the slots 50 may vary depending upon the lamp being used and/or the environment in which the lamp holder 10 may be used. The slots 50 may be substantially linear (as shown in FIGS. 1 and 2) or form a zigzag pattern as shown in FIG. 3. One of ordinary skill in the art will readily appreciate that any pattern of slot or formation of the vibration dampener is within the scope of the present invention so long the element provides the functionality as described herein. For example, the vibration dampeners 22 may be spaced uniformly (equidistantly) or non-uniformly about the perimeter of the conductive sleeve 18. The size and shape of the vibration dampeners 22 may likewise be substantially similar or distinct.

The vibration dampeners 22 function to increase the resistance in the interference fit between the formed threads 46 of the lamp holder 10 and the base threads 38 of the lamp 12. This is generally accomplished by decreasing at least a portion of the radius associated with the formed threads 46 of the conductive sleeve 18. In one aspect of the invention, the vibration dampeners 22 may be adjusted to increase or decrease the resistance between the base threads 38 of the lamp 12 and the formed threads 46 of the conductive sleeve 18 of the lamp holder 10.

As discussed above, the lamp holder 10 further includes a conductive contact arm 24 that is arranged to engage flat contact 42 (or button) of lamp 12 and is electrically insulated from conductive sleeve 18. The conductive contact arm 24 is secured to the lamp holder 10 by a screw 49 that is secured to the body 14 of the lamp holder 10, as shown in FIG. 2. Conductive contact arm 24 is cantilever mounted to the body 14 at a first end 52 and the free end 54 extends generally upward for contacting the flat contact 42 (or button) of lamp 12.

Conductive sleeve 18 is one conductor of an AC supply (not shown). Conductive sleeve 18 is connected to the AC supply through the conductor screw 28 and lead wire 30B. Conductor screw 28 may also function to secure the conductive sleeve 18 to the lamp holder 10. As shown in FIGS. 2 and 3, conductive contact arm 42 is also connected the AC supply (not shown) to provide current to operate lamp 10 through lead wire 30A that is connected to the contact arm 24 as is well known in the art (e.g., soldering, securing to screw 48, etc.).

As shown in FIG. 4, lamp 12 has been inserted into lamp holder 10 and conductive base threads 38 advanced along formed threads 46. The contact 42 (or button) actuates the arm 24 to compress the spring 26 such that the contact 42 makes solid contact with conductive contact arm 24, allowing current to flow and lighting lamp 10. If the lamp 12 includes a prong 40, the prong may be engaged with the positioning element 20.

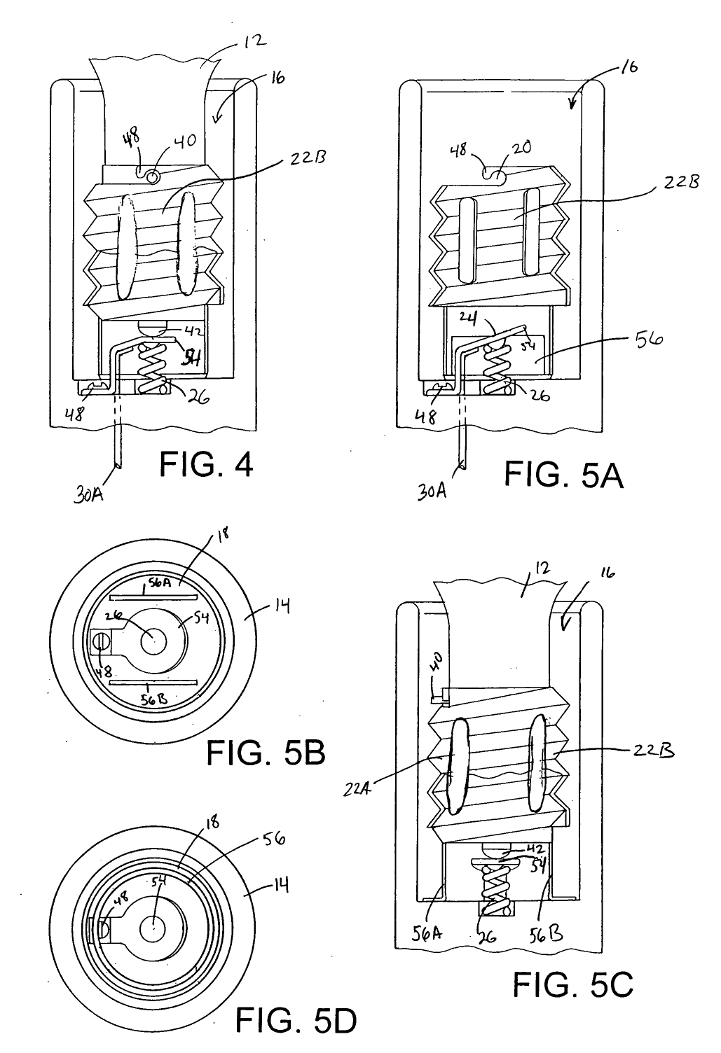

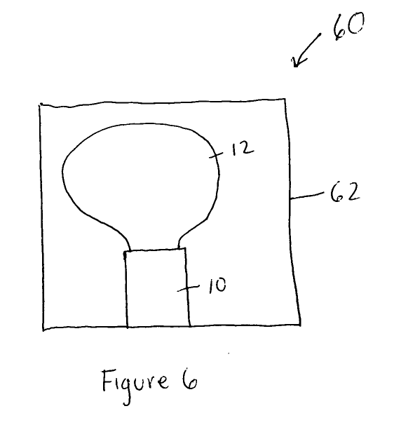

In another embodiment, shown in FIGS. 4, 5A-5C, the lamp holder 10 may further include tabs 56A and 56B. Tabs 56A and 56B are located at the bottom of the socket 16 and are secured to the body 14 by screws 28 and 49, respectively. As shown in FIG. 4, the tabs 56A and 56B are located symmetrically about the free end 54 of the contact arm 42. The tabs 56A and 56B provide additional stability to the lamp 12. The stability offered by the tabs 56A and 56B is provided even if the lamp holder 10 is not equipped with the vibration dampeners 22 and/or the positioning element 20. One of ordinary skill in the art will readily appreciate that the precise positioning or arrangement of the tabs is dependent on the size and type of the lamp and lamp holder and all variations are deemed to be within the scope of the present invention. In addition, the tabs 56 can be linear and/or curved. For example, a single annular (or circular) tab 56, as shown in FIG. 5D may be placed in the base of the socket 16 or a number of tabs spaced uniformly (equidistantly) or non-uniformly about the base of the socket 16 may be used in accordance with the present invention.

As shown in FIGS. 5A and 5C, the height of the tabs 56A and 56B may generally be shorter than the free end 54 of the contact arm 24 in its initial state. For example, the tabs 56A and 56B may be about ⅛ to ½ inch lower than the height of the free end 54 in its initial state. This allows for sufficient engagement of the free end 54 of the contact arm 24 with the flat contact 42 of the lamp 12. In addition, since the tabs 56A and 56B can allow greater airflow around the base of the bulb to assist in dissipating heat and/or the tabs 56A and 56B further provide a thermal insulating function to the lamp holder 10, which may increase the operational viability of the lamp holder 10.

FIG. 6, illustrates a lamp fixture 60 in accordance with the present invention. The lamp fixture 60 includes a lamp holder 10 as discussed above, a lamp 12 and a housing 62. The lamp fixture 60 may be used in any environment. For example, the lamp fixture 60 may be used in the following lighting applications: athletic fields, gymnasiums, roadways, runways, factories, warehouses, etc. One of ordinary skill in the art will readily appreciate that lamp fixtures in accordance with the present invention may take any form and shape. In addition, the lamp fixture in accordance with the present invention may be used in any lighting application.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An apparatus comprising:
a conductive sleeve including a top portion, a central portion and a bottom portion, wherein at least one portion of the conductive sleeve is at least partially threaded for receiving an associated lamp;
a lamp positioning element located adjacent the top portion of the conductive sleeve for engaging a prong from an associated lamp; and
the conductive sleeve including at least one vibration dampener secured to a portion of the conductive sleeve.

2. The apparatus of claim 1, wherein the conductive sleeve is made of a metal.

3. The apparatus of claim 1, wherein the vibration dampener is formed by at least one slot formed in the conductive sleeve.

4. The apparatus of claim 1, wherein the vibration dampeners are spaced equidistantly about a perimeter of the conductive sleeve.

5. The apparatus of claim 1, wherein the vibration dampeners are not spaced equidistantly about a perimeter of the conductive sleeve.

6. The apparatus of claim 1, wherein two vibration dampeners are formed in the conductive sleeve.

7. The apparatus of claim 1, wherein the vibration dampener is a portion the sleeve disposed between a pair of slots, wherein at least a portion of the vibration dampener is bent radially inward.

8. The apparatus of claim 1, wherein the lamp positioning element is a notch formed between a flared notched end and the sleeve for receiving a prong from an associated lamp.

9. A lamp holder comprising:
a body made of an insulating material that forms a socket;
a conductive sleeve secured to the body, the conductive sleeve having a top portion, a central portion and a bottom portion, wherein at least one portion of the conductive sleeve is at least partially threaded;
a positioning element located near the top portion of the conductive sleeve; and
at least one vibration dampener formed in a portion of the conductive sleeve.

10. The lamp holder of claim 9 further including at least one tab in the bottom portion of the conductive sleeve for contacting an associated lamp.

11. The lamp holder of claim 9 further including a spring secured against the body and a conductive contact arm.

12. The lamp holder of claim 9, wherein the insulating material is selected from the consisting of at least from the group of: porcelain, plastic, and rubber.

13. The lamp holder of claim 9, wherein the conductive sleeve is made of a metal.

14. The lamp holder of claim 9, wherein the conductive sleeve is removably secured to the body.

15. The lamp holder of claim 9, wherein the at least one vibration dampener is at least partially formed in partially threaded portion of the conductive sleeve.

16. The lamp holder of claim 9, wherein the positioning element is a notch formed in the sleeve.

17. The lamp holder of claim 16, wherein the notch engages at least a portion of an associated lamp.

18. The lamp holder of claim 9, wherein the vibration dampener is formed by at least one slot formed in the conductive sleeve.

19. The lamp holder of claim 18, wherein the vibration dampeners are spaced equidistantly about a perimeter of the conductive sleeve.

20. The lamp holder of claim 18, wherein the vibration dampeners are not spaced equidistantly about a perimeter of the conductive sleeve.

21. The lamp holder of claim 9, wherein two vibration dampeners are formed in the conductive sleeve.

22. A light fixture comprising:
an apparatus according to claim 1; and
a housing to which the apparatus is secured.

23. A light fixture comprising:
a lamp holder according to claim 1; and
a housing to which the lamp holder is secure.
